(19) United States
(12) Patent Application Publication
(10) Pub. No.: US 2004/0052473 A1
(43) Pub. Date: Mar. 18, 2004

(54) Optical fiber connector part

(75) Inventors: Koji Seo, Tokyo (JP); Masato Shiino, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: THE FURUKAWA ELECTRIC CO., LTD., Tokyo (JP)

(21) Appl. No.: 10/652,070

(22) Filed: Sep. 2, 2003

(30) Foreign Application Priority Data
Sep. 3, 2002 (JP) 2002-257839

(51) Int. Cl. G02B 6/36

(52) U.S. Cl. 385/73

(57) ABSTRACT

There is provided an optical fiber connector part comprising a housing which internally holds the end of an optical transmission route, and a shutter part which shields an output light beam from the optical transmission route in the housing or releases the output light beam, wherein the shutter part has an optical diffusing reflection surface which diffuses and reflects the output light beam when the output light beam is shielded.

Damages of the shutter part caused by the high power light beam can be prevented with diffusing and reflecting the output light beam by the optical diffusing reflection surface. Damage of the parts caused by the reflecting light beam can also be prevented with dissipating energy of the reflecting light beam from the shutter part.

### FIELD OF THE INVENTION

The present invention relates to optical fiber connector parts to prevent outside leakage of a laser beam which has ill effects on human bodies. Optical fiber connector parts include all the optical parts that need to prevent outside leakage of laser beams at the end of an optical transmission route. Therefore an optical fiber connector adapter, an optical fiber connector plug, an optical fiber connector plug cap and the like, which have connecting or ending functions at the end of the optical transmission route, are also included in the optical fiber connector parts.

### RELATED ART

Recently a high power optical signal such as a laser beam and the like is used in optical communication systems along with popularization of the WDM systems. When an optical signal is high-powered, the concern about safety for human bodies, especially for eyes is raised. Basically an optical transmission route is safe because the optical transmission route itself is considered to be a closed circuit. However if a connecting part of the optical transmission route is cut off or decoupled, a certain measure for safety shall be taken because of outside leakage of the optical signal.

An optical fiber connector part with a shutter device such as an optical fiber connector adapter with a shutter device, an optical fiber connector plug with a shutter device and the like is proposed as one of the measures for safety. The shutter device is made of metals or plastics, and has functions to open or close according to the status whether the optical connector is attached or detached. When the optical connector is detached, the shutter device is closed to protect human eyes from outside leakage of the optical signal. The above-mentioned invention of the shutter device is described in Japanese provisional publication of utility model #H7-19713 and Japanese provisional publication of patent #2001-66470.

However the ordinary shutter device has risk that the shutter device itself or its peripheral device is damaged because power of an optical signal is increased to obtain large capacity for optical communications or a long distance optical communications. For example, power of an optical signal will reach several hundred mW when plural wavelengths of exciting lights are combined. It is also possible that an exciting light with W level power is transmitted in the optical fiber when a Raman amplifier which combines the exciting light with light signals with plural wavelengths to obtain wide gain bands.

If an optical signal with 100 mW power or more is transmitted, there is risk that a shutter part or a housing of a shutter device is damaged by the high power optical signal because materials of ordinary shutter devices are plastics or metals. For example, the shutter device is heated by absorbing optical power and its temperature raised. Therefore there is risk that plastic materials of the shutter will be melted or burnt in the case that a shutter is made of plastics when a high power laser beam is projected.

In the case that a shutter is made of metals, risk of damages of the shutter part itself is decreased because melting temperature of metals is high. However there is risk that plastic materials of the housing are melted or burnt by a laser beam reflecting from the metal surface of the shutter. Such phenomenon causes not only damages of optical fiber connector parts such as an optical adapter but also fires or burn injuries.

### SUMMARY OF THE INVENTION

One purpose of the present invention is to provide an optical fiber connector part which shields a high power output light such as an optical signal, an exciting light and the like and prevents outside leakage of the high power output light from the end of the optical transmission route together with preventing damages of parts.

Reason why plastics are melted or burnt by energy from several hundred mW to several W is that a beam spot of a light beam projected from optical fibers is small. Therefore if the beam spot is small, temperature of the beam spot is raised very much because optical energy is concentrated into very small area (high energy density). In the present invention, the above mentioned problem is solved by broadening or diffusing a beam spot. Optical energy can be absorbed in a wide area and the heating area can be diffused by broadening the beam spot. It can prevent high temperature in a small area. Therefore high temperature, which makes plastics melted or burnt, can be prevented and durability of plastic parts can be raised.

The first embodiment of the optical fiber connector part of the present invention is an optical fiber connector part comprising a housing internally holding the end of an optical transmission route, and a shutter part shielding or releasing an output light beam from said optical transmission route in said housing, wherein said shutter part has an optical diffusing reflection surface diffusing and reflecting said output light beam when said output light beam is shielded or released.

In this embodiment, a reflecting light beam of the shielded high power laser beam can be diffused. It can prevent high temperature, and melting or burning of the parts. Therefore damages of the shutter part caused by the high power output light beam can be prevented with diffusing and reflecting the output light beam from the optical diffusing reflection surface, and damages of the parts caused by the reflecting light beam can also be prevented by dissipating energy of the reflecting light beam from the shutter part.

Another embodiment of the optical fiber connector part of the present invention is the optical fiber connector part, wherein said optical diffusing reflection surface of said shutter part comprises an optical reflection surface having plural concavities and convexities. In this embodiment, position, size and shape of concavities and convexities of the reflection plate can be both irregular and regular. The projected laser beam is dissipated to any directions, and energy of the high power laser beam is scattered, and generation of high temperature is restrained.

Another embodiment of the optical fiber connector part of the present invention is the optical fiber connector part, wherein said optical diffusing reflection surface of said shutter part has a convex curved surface to the projected light beam. In this embodiment, the beam spot is broadened and energy of the laser beam is diffused because the output light beam (a laser bean and the like) is diffused outwards.

Another embodiment of the optical fiber connector part of the present invention is the optical fiber connector part, further comprising one or more optical reflection plates having optical diffusing reflection surfaces to reflect the reflecting light beam from said shutter part. In this embodiment, the output light beam (a laser beam and the like) can be dissipated with more reliability because the reflecting light beam from the shutter part is further diffused.

Another embodiment of the optical fiber connector part of the present invention is the optical fiber connector part, wherein said optical reflection plate includes a first optical reflection plate diffusing and reflecting the reflecting light beam from said shutter part, and a second optical reflecting plate diffusing and reflecting the reflecting light beam from said first optical reflection plate. In this embodiment, it is possible to further diffuse the reflecting light beam. Damages of the parts can surely be prevented by such multiple reflecting construction in the case that an extremely high power light beam is projected. It is also possible to add a third reflection plate which reflects the reflecting light beam from the second reflection plate.

Another embodiment of the optical fiber connector part of the present invention is the optical fiber connector part, wherein at least one of said optical reflection plates is combined with said shutter part. In this embodiment, the following advantage will be expected by combining the shutter part and the optical reflection part into one part: quantity of the parts can be reduced, and additionally the optical reflection plate can be positioned precisely, and simple construction and easy assembly can be realized.

Another embodiment of the optical fiber connector part of the present invention is an optical fiber connector part comprising:

means for holding the end of an optical transmission route;

means for shielding or releasing an output light beam from said optical transmission route in said housing; and

means for diffusing and reflecting said output light beam when said output light beam is shielded or released.

### BRIEF DESCRIPTION OF THE DRAWINGS

FIG. 1A is a schematic view for illustrating one example of an optical fiber connector adapter with a shutter part to which the present invention is applicable.

FIG. 1B is a perspective view for illustrating an exterior of the shutter part.

FIG. 2A is a schematic view for illustrating an optical fiber connector part (an optical fiber connector adapter) as one embodiment of the present invention.

FIGS. 2B and 2C are perspective views for illustrating other embodiments of the optical fiber connector part.

FIGS. 3A, 3B and 3C are schematic views for illustrating other embodiments of the optical fiber connector part.

FIGS. 4A and 4B are schematic views for illustrating other embodiments of the optical fiber connector part.

FIGS. 5A and 5B are schematic views for illustrating an optical fiber connector plug cap to which the present invention is applicable as other embodiments of the present invention.

FIGS. 6A and 6B are perspective views for illustrating a shutter part as other embodiments of the present invention.

FIG. 7 is a schematic view for explaining the effect of the shutter part when a laser beam is shielded by a shutter part of the related art.

### DETAILED DESCRIPTION OF PREFERRED EMBODIMENTS

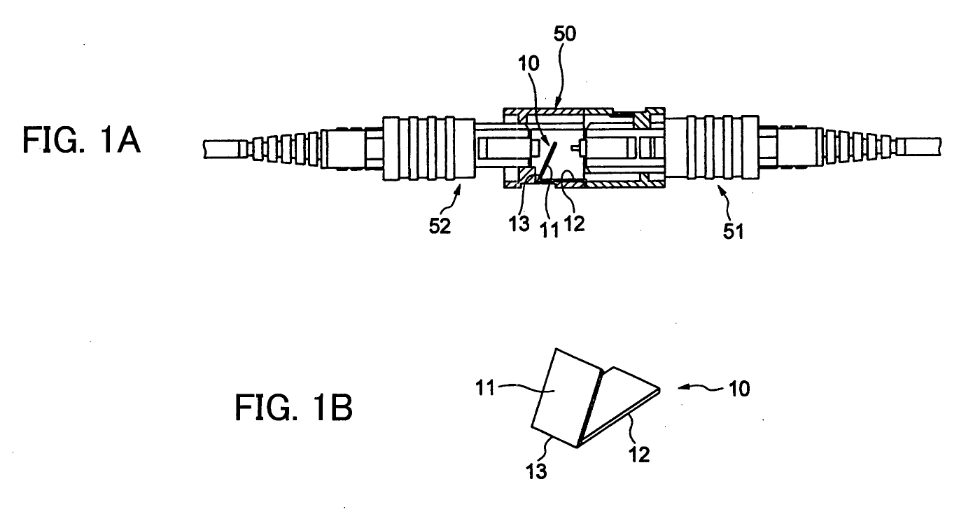

Referring to the attached drawings, various preferred embodiments of the present invention will be explained. FIG. 1 is a drawing for illustrating an optical adapter connector which has a shutter part as an example of an electrical connector part to which the present invention can be applied. The drawing FIG. 1A is a schematic view for illustrating an optical fiber connector adapter 50 to which an optical connector 51 is connected from one side and to which an optical connector 52 is just before connected from the other side. The optical adapter 50 is illustrated in a sectional view so as to easily understand the connection between the optical fiber connector adapter 50 and a shutter part 10. FIG. 1B is a perspective view for illustrating an exterior of the shutter part 10.

The shutter part 10 consists of a fixing part 12 which is connected to the optical fiber connector adapter 50 and a blocking piece 11 which is bent up at a predetermined bending angle so as to block off an optical transmission route. In the shutter part 10, the fixing part 12 is connected to an inner surface of the optical fiber connector adapter 50 and the blocking piece 11 blocks off the optical transmission route before an optical connector 92 is inserted.

If the optical connector 52 is inserted, the blocking piece 11 of the shutter part 10 is pressed toward the insert direction (rightward in the drawing). A lifting part 13 of the shutter part is pressed and bent by the insert force of the optical connector 52, and the blocking piece 11 is pressed against both sides of inner surfaces of the optical fiber connector adapter 50. Therefore edge surfaces of ferrules of the optical connector 51 and 52 are faced each other and optical transmission can be performed. If the optical connector 52 is removed from the optical fiber connector adapter 50, outside leakage of the projected laser beam from an optical connector 91 can be prevented because the blocking piece 11 returns to the former blocking position (position shown in FIG. 1A) by an elastic force of the lifting part 13 and blocks off the optical transmission route.

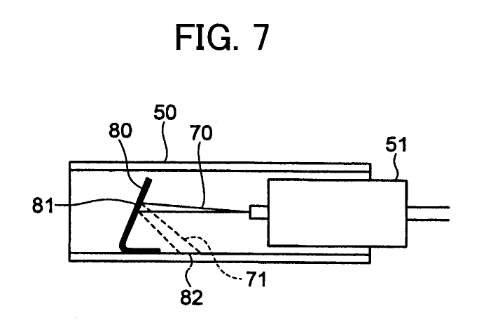

FIG. 7 is a schematic view for explaining the effect of a shutter part if the laser beam is shield by a shutter part 80 of the prior art. The same part number as FIG. 1 are used except the shutter part 80. FIG. 7 is illustrated schematically without detailed parts so as to explain plainly. In the case that the shutter part 80 of the prior art is made of plastics, temperature of an optical receiving part 81 of the shutter part is raised because of a small beam spot of an laser beam 70, and there is risk that the plastics will be melt or burnt. In the case that the shutter part 80 of the prior art is made in metals, the laser beam 70 reflects from the optical receiving part 81 and a reflecting laser beam 71 is projected into a part of housing 82 of the optical fiber connector adapter 50. There is risk that the projected part 82 will be melt or burnt because a beam spot of the reflecting laser beam 71 is small and the housing 50 is made of plastics.

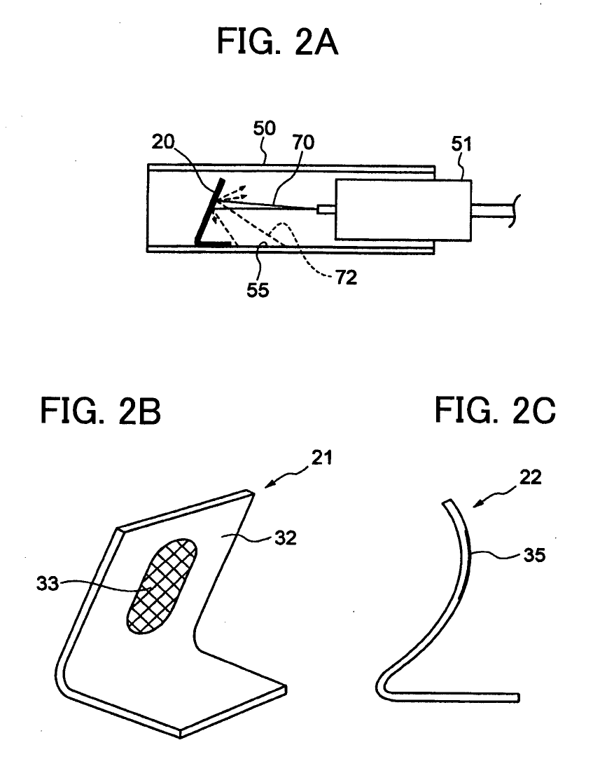

FIG. 2 is a schematic view for illustrating one embodiment of the optical fiber connector part (the optical fiber connector adapter 50) of the present invention. It is possible to prevent the melting caused by the laser beam 70 if the optical receiving surface of the shutter part 10 diffuses or scatters the laser beam 70 during reflection. Therefore the optical receiving part of the shutter part 10 of the present invention has an optical diffusion construction that diffuses (including scattering) the laser beam during reflection. Therefore the laser beam spot spreads out by the diffusion or scattering of the reflecting laser beam 72 as illustrated in FIG. 2A. If a projected area 55 of the reflecting laser beam 72 spreads out, temperature of the projected area is hardly raised because energy of the laser beam 70 is dispersed.

One method to obtain an optical diffusion effect is to have a curved surface to reflect a light beam. Basically a smaller curvature has a larger optical diffusion effect. However lessening the curvature is limited by the constructional reason, and reflecting direction is limited. Therefore it will obtain a larger optical diffusion effect to make spherical dents by embossing finish or the like.

FIG. 2B is a perspective view for illustrating another embodiment of an optical fiber connector part 21 of the present invention. An optical receiving surface 33, which is a back side 32 of the shutter part 21, has an optical diffusing reflection surface. The optical diffusing reflection surface can be realized by, for example, making small concavities and convexities on the optical receiving surface. The reflecting light beam is diffused to random directions because a projection angle to the optical receiving surface becomes random by the small concavities and convexities. The construction with the small concavities and convexities can be produced if the optical receiving surface is finished roughly. The roughness (Ra) normally ranges from 0.1 μm to 10 μm with sandblasting finish

The optical diffusing reflection surface can also be produced with embrocating materials for a sintered plate of aluminum oxide (Al₂O₃) or a diffusion plate such as powder pressurization of barium sulfide (BaSo₄) and the like. Though materials with higher melting temperature are preferable, metals are not mandatory. A size of powders should range from 0.1 μm to 10 μm, which is almost the same size as wavelength of an optical signal. If an optical signals is a near infrared light, a size of powders preferably ranges around from 0.5 μm to 2 μm.

If the shutter part is made of plastics, it is also possible to have the optical diffusion construction with attaching the optical diffusion film to the surface as mentioned above. Though FIG. 2B shows the example that has the optical diffusion construction on the optical receiving surface 33, it is also possible to have the optical diffusion construction on all the lifting surface including all front and back surfaces, or all the surfaces of the shutter part 21.

FIG. 2C shows another embodiment of the shutter part in which the present invention is applicable. In a shutter part 22 of this embodiment, an optical receiving surface 35 of the laser beam has a reflection plate with a convex curved surface to the projecting direction. Therefore the reflecting laser beam spreads out and its beam spot becomes larger. In the shutter part 22, it is possible to have the convex curve surface only on the back surface and it is also possible to have convex curve surfaces on all the lifting surface of the shutter part 22.

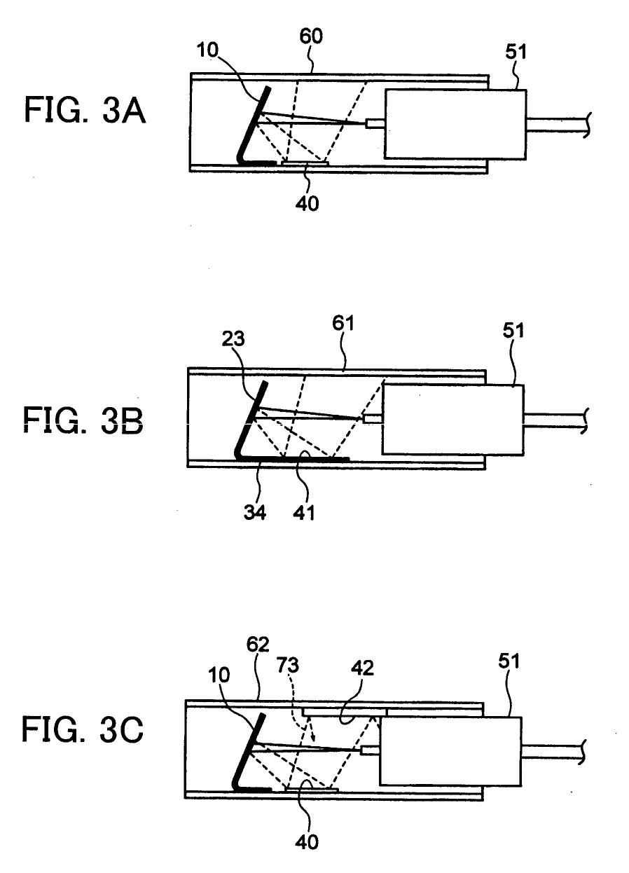

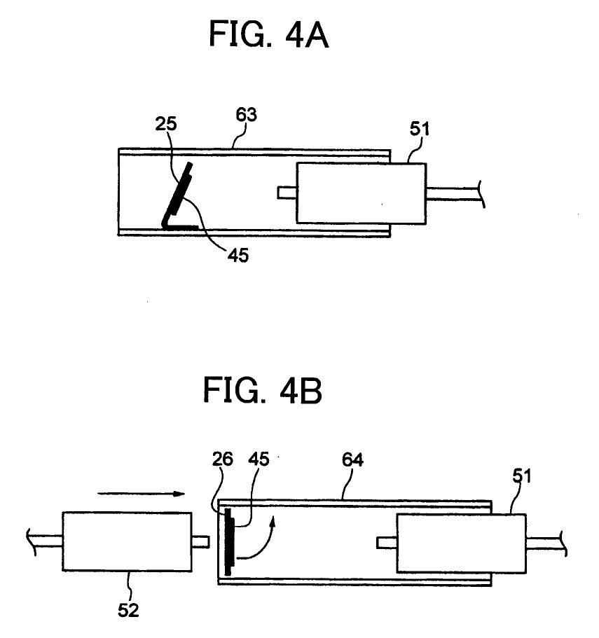

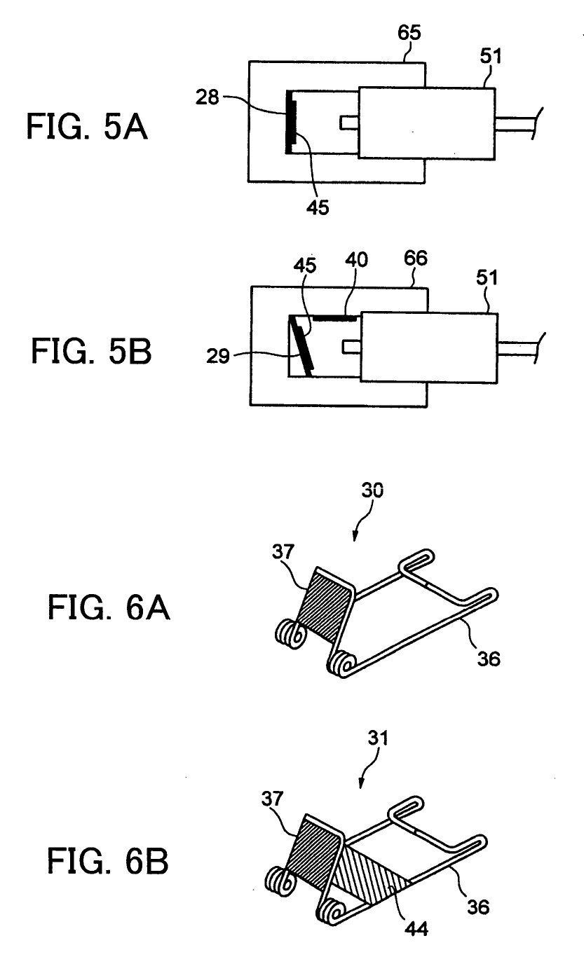

FIG. 3, FIG. 4 and FIG. 5 are drawings for illustrating other embodiments of an optical fiber connector part of the present invention. An optical fiber connector part 60 as shown in FIG. 3A includes a second reflection plate 40 which reflects the reflecting laser beam from the optical receiving surface of the shutter part 10. If the second reflection plate 40 has an optical diffusing reflection surface, the reflecting laser beam can be further diffused. In a shutter part 23 of an optical fiber connector part 61 as shown in FIG. 3B, a surface 41 of a fixing part (a pedestal part) 34 has an optical diffusing reflection surface. Such shutter part has construction to combine the shutter part 10 as shown in FIG. 3A and the second reflection plate 40 into one, and has advantages such as simple construction or easy assembly. An optical fiber connector part as shown in FIG. 3C has a third reflection plate 42 which has a optical diffusing reflection surface in addition to the second reflection plate 40. Energy of a high power laser beam can be further reduced because the third reflection plate 42 reflects and diffuses the reflecting light 73 from the second reflection plate. It is effective for optical communication systems to transmit strong laser beams.

FIG. 4 is a schematic view for illustrating an optical fiber connector part of another embodiment of the present invention. In a shutter part 25 of an optical fiber connector part 63 as shown in FIG. 4A, an optical diffusion film 45 with an optical diffusing reflection surface is fixed (Any adhesive method is available.) to the optical receiving surface. The optical diffusion film 45 can be produced with embrocating materials for a sintered plate of aluminum oxide (Al₂O₃) or a diffusion plate such as powder pressurization of barium sulfide (BaSo₄) and the like. The optical diffusion film 45 can also be produced with finishing one side of the metal film. FIG. 4B shows an optical fiber connector part 64 as another embodiment of the present invention. When the optical connector 52 is inserted into the optical fiber connector part 64, the shutter part 26 is pressed by the optical connector 52 and moves upward

FIG. 5 is a schematic view for illustrating an optical fiber connector plug cap 65 for the optical connector 51 as one embodiment of the present invention. The laser beam is shielded when the optical connector 51 is inserted into the optical fiber connector plug cap 65. It is also required to diffuse the high power laser beam as much as possible to prevent melting of the optical fiber connector plug cap 65. Therefore an optical diffusing reflection plate 28 is attached to the inside of the optical fiber connector plug cap 65 to diffuse the laser beam. The optical diffusion film 45 is fixed to the optical receiving surface in the optical diffusing reflection plate 28.

FIG. 5B is a schematic view for illustrating another embodiment of the shutter part to which the present invention is applicable. In this embodiment, an optical diffusing reflection plate 29 is installed with the slant angle to the laser beam direction and the first reflection plate 40 is fixed to the optical fiber connector plug cap 66. Therefore there are the following advantages: the laser beam is not transmitted backward, and the laser beam can be further diffused.

FIG. 6 is a perspective view for illustrating another embodiment of the shutter part to which the present invention is applicable. A shutter part 30 as shown in FIG. 6A consists of a framework 36 made of metal rods and blocking piece 37 which is fixed to the framework 36. A back side of the blocking piece 37 has optical diffusing reflection construction (which is not shown in the drawing). The shutter part 31 as shown in FIG. 6B has a second reflection plate 44 in the fixing part (the pedestal part).

As explained above, a beam spot of a laser beam projected to plastics can be broadened or diffused by diffusing and reflecting the light beam with using an optical diffusing reflection surface, and it can prevent local high temperature in the part of optical parts. Therefore it can prevent damages of the shutter part such as melting and the like, and it can also prevent damages of the parts caused by reflecting light beams from the shutter part.

What is claimed is:

1. An optical fiber connector part comprising:
a housing internally holding the end of an optical transmission route; and
a shutter part shielding or releasing an output light beam from said optical transmission route in said housing,
wherein said shutter part has an optical diffusing reflection surface diffusing and reflecting said output light beam when said output light beam is shielded or released.

2. The optical fiber connector part as claimed in claim 1, wherein said optical diffusing reflection surface of said shutter part comprises an optical reflection surface having plural concavities and convexities.

3. The optical fiber connector part as claimed in claim 1, wherein said optical diffusing reflection surface of said shutter part has a convex curved surface to the projected light beam.

4. The optical fiber connector part as claimed in claim 1 further comprising one or more optical reflection plates having optical diffusing reflection surfaces to reflect the reflecting light beam from said shutter part.

5. The optical fiber connector part as claimed in claim 2, further comprising one or more optical reflection plates having optical diffusing reflection surfaces to reflect the reflecting light beam from said shutter part.

6. The optical fiber connector part as claimed in claim 3, further comprising one or more optical reflection plates having optical diffusing reflection surfaces to reflect the reflecting light beam from said shutter part.

7. The optical fiber connector part as claimed in claim 4, wherein said optical reflection plate includes a first optical reflection plate diffusing and reflecting the reflecting light beam from said shutter part, and a second optical reflecting plate diffusing and reflecting the reflecting light beam from said first optical reflection plate.

8. The optical fiber connector part as claimed in claim 5, wherein said optical reflection plate includes a first optical reflection plate diffusing and reflecting the reflecting light beam from said shutter part, and a second optical reflecting plate diffusing and reflecting the reflecting light beam from said first optical reflection plate.

9. The optical fiber connector part as claimed in claim 6, wherein said optical reflection plate includes a first optical reflection plate diffusing and reflecting the reflecting light beam from said shutter part, and a second optical reflecting plate diffusing and reflecting the reflecting light beam from said first optical reflection plate.

10. The optical fiber connector part as claimed in claim 4, wherein at least one of said optical reflection plates is combined with said shutter part.

11. The optical fiber connector part as claimed in claim 5, wherein at least one of said optical reflection plates is combined with said shutter part.

12. The optical fiber connector part as claimed in claim 6, wherein at least one of said optical reflection plates is combined with said shutter part.

13. The optical fiber connector part as claimed in claim 7, wherein at least one of said optical reflection plates is combined with said shutter part.

14. The optical fiber connector part as claimed in claim 8, wherein at least one of said optical reflection plates is combined with said shutter part.

15. The optical fiber connector part as claimed in claim 9, wherein at least one of said optical reflection plates is combined with said shutter part.

16. An optical fiber connector part comprising:
means for holding the end of an optical transmission route;
means for shielding or releasing an output light beam from said optical transmission route in said housing; and
means for diffusing and reflecting said output light beam when said output light beam is shielded or released.
